(19) United States
(12) Patent Application Publication
(10) Pub. No.: US 2011/0017043 A1
(43) Pub. Date: Jan. 27, 2011

(54) SAW BLADE AND SAW BLADE ASSEMBLY

(76) Inventors: Don L. Angelo, Phillips, WI (US); Ron E. Angelo, Phillips, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/829,517

(22) Filed: Jul. 2, 2010

Related U.S. Application Data
(60) Provisional application No. 61/227,214, filed on Jul. 21, 2009.
(60) Provisional application No. 61/257,125, filed on Nov. 2, 2009.

(51) Int. Cl. B26D 1/12

(52) U.S. Cl. 83/676

(57) ABSTRACT

A saw blade assembly has a thin saw plate and a pair of collars, one to each side of the plate. The plate and collars include a center spindle hole, the spindle holes aligning with one another, and a plurality of secondary holes. The secondary holes are used to insert a fastener through the three elements. Alternatively, the thin saw plate is used with two collars that are not identically configured. One collar includes a center bushing having a spindle hole. The center bushing is longer than the first collar is thick and extends outwardly to one side of the collar. The saw plate and a second collar each includes a hole that accommodates the diameter of the center bushing such that the plate and the second collar fit over the bushing. Secondary holes are included to allow for the insertion of fasteners through common holes in the three elements.

This Application claims the benefit of U.S. Provisional Application No. 61/227,214, filed Jul. 21, 2009, and U.S. Provisional Application No. 61/257,125, filed Nov. 2, 2009.

### FIELD OF THE INVENTION

The present invention relates generally to cutting machines and to saw blades for rotary or circular saws that are used with such machines. More specifically, it relates to a saw blade assembly that is especially adapted to strengthen a saw blade body and to reduce saw blade vibration, particularly in saw blades of relatively thin cross-section.

### BACKGROUND OF THE INVENTION

In the art of saw blades, a typical saw configuration usually comprises a number of separate pieces, each of which is individually slid onto an arbor spindle and secured together with a spindle nut on the arbor. The pieces used in this typical configuration include the saw blade itself together with one or two spacers. The spindle arbor is the area where the saw blade and spacer or spacers are mounted in the cutting machine.

The disadvantage of this old methodology is that the clamping force used to hold the spacers together is typically located at the center of the spacers, thus causing the outer diameters of the spacers to “float” in and out without any support. This is known to cause the saw blade to “wander” while it is cutting. This is also known to cause saw dust to easily build up between the saw spacers and the saw blade, thus increasing the wobbling problems of the saw blade. A wobbling saw blade produces a bad finishing cut and prematurely wears the saw blade. In the experience of these inventors, all of the problems mentioned above increase material costs, electrical costs, noise pollution, accumulated waste and “chip out” problems.

### SUMMARY OF THE INVENTION

The saw blade and saw blade assembly of the present invention has solved the wobbling problem mentioned above, thus producing smoother finishes and longer saw run time. Also, thinner saw blades are able to save on material costs because a thin saw blade produces less saw dust. The saw blade and saw blade assembly of the present invention also reduces electrical costs because it takes less horse power to run a thinner saw blade through the product being cut. It also reduces noise pollution because a thin saw blade lessens the noise of the cutting process, noise that is inherent in the process of cutting due to the high circumferential speed at with such blades rotate and the mechanical vibrations that are generated as a result of such rotation. Finally, the saw blade and saw blade assembly of the present invention reduces accumulated waste because a thin saw blade produces less saw dust and reduces chip-out problems because the edge of a thin saw blade hits less surface area as it cuts through the product.

All of these features have resulted in a saw blade and saw blade assembly that produces a superior quality end product for the consumer, and at a lower cost. In addition, the saw blade and saw blade assembly of the present invention provides a thinner, but substantially stronger, saw blade that is able to cut through deeper material, is more accurate in cutting, and is easier for the operator to load onto the spindle arbor. The support structure also functions as a stiffener and as a heat sink that draws heat away from the saw blade during the cutting process. Furthermore, the support structure used in the saw blade and saw blade assembly of the present invention help eliminate harmonic vibrations of the saw blade steel and the resulting noise generated thereby.

In a first embodiment of the saw blade and saw blade assembly of the present invention, a saw body, or plate, having a thin blade is utilized in combination with a pair of collars or spacers, one disposed to each side of the saw body or plate. Each saw body or plate and collar or spacer includes a center spindle hole, the spindle holes aligning with one another, and a plurality of secondary holes positioned in a proximal portion of each of those structures. The secondary holes are used, in the preferred embodiment, to insert a fastener through the common hole of each of the three elements, such fastener being a rivet, for example. It is to be understood, however, that the collars or spacers could be attached to the saw body or plate by means of screws, nuts and bolts, solder, glue or other types of fastening methods that secure one collar or two collars to a body of a saw plate to strengthen it and without deviating from the scope of the present invention.

In a second embodiment of the saw blade and saw blade assembly of the present invention, a saw body, or plate, also having a thin blade, is utilized in combination with two collars or spacers, one disposed to each side of the saw body or plate. In this second embodiment, however, the two collars or spacers are not identically configured. That is, the first collar or spacer includes a center bushing. The bushing has a spindle hole defined in it. The center bushing is longer than the first collar or spacer is thick and extends outwardly to one side of the collar or spacer. The saw body or plate and the second collar or spacer each includes a hole that accommodates the diameter of the center bushing such that the saw body or plate and the second collar or spacer slidingly fit over the bushing. Secondary holes are included to allow for the insertion of fasteners through common holes of each of the three elements, such fasteners being screws, for example. It is to be understood, however, that other fasteners or fastening means could be used as mentioned above.

The foregoing and other features of the saw blade and saw blade assembly of the present invention will be apparent from the detailed description that follows.

### BRIEF DESCRIPTION OF THE DRAWINGS

FIG. 1 is a front elevational view of the first embodiment of a saw blade assembly fabricated in accordance with the present invention.

FIG. 2 is a top plan and cross-sectioned view of the saw blade assembly illustrated in FIG. 1 and taken along line 2-2 of FIG. 1.

FIG. 3 is an enlarged partial and cross-sectioned view of the saw blade assembly shown in FIG. 1 and taken along line 3-3 of FIG. 1.

FIG. 4 is a top plan and exploded view of the second embodiment of a saw blade assembly fabricated in accordance with the present invention.

FIG. 5 is also a top plan and cross-sectioned view of the saw blade assembly illustrated in FIG. 4.

### DETAILED DESCRIPTION

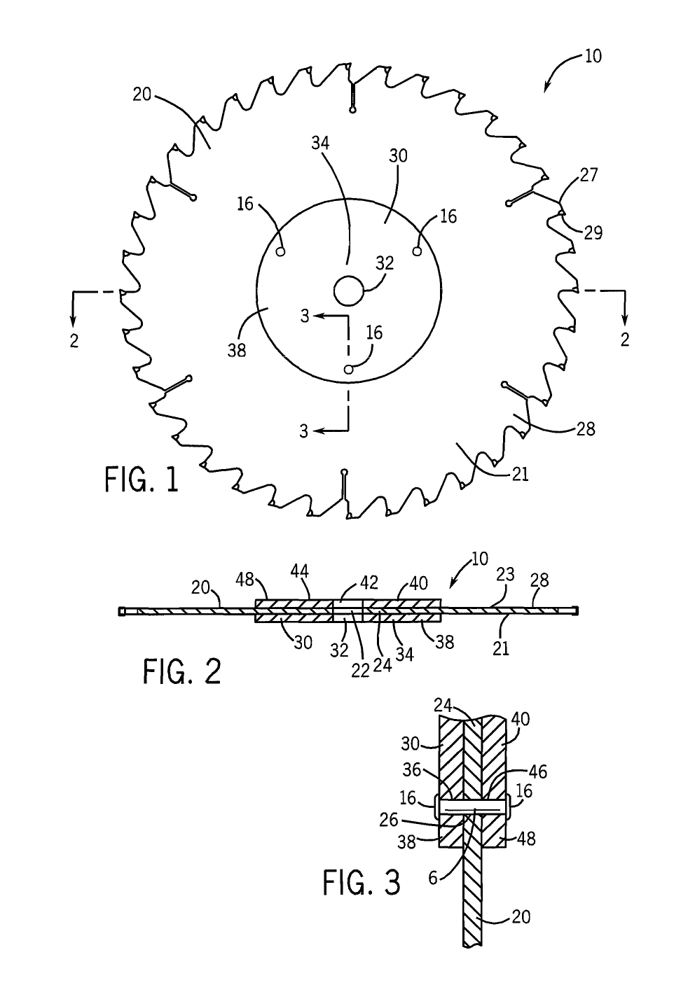

Referring now to the drawings where like elements are represented by like numbers throughout, a saw blade assembly, generally identified 10, that is constructed in accordance with the present invention is shown. The saw blade assembly 10 comprises a disk-like saw body or plate 20 having a diameter. See FIG. 1. In the preferred embodiments illustrated, the saw body or plate 20 is a ten-inch diameter thin kerf carbide-tipped steel saw blade. The plate thickness is 0.035 inches. The saw body or plate 20 used in the present invention is not limited to that diameter of saw blade and is not limited in the material from which the saw blade is made.

In a first preferred embodiment of the present invention, which is illustrated in FIGS. 1-3, it will be seen that a collar or spacer 30, 40 is disposed to each side 21, 23 of the saw body or plate 20, respectively. The saw body or plate 20 comprises a center spindle hole, a saw body portion 24 that is proximal to the center spindle hole 22, a saw body portion 28 that is distal to the center spindle hole 22, and a peripheral saw tip or kerf edge 27, the kerf edge 27 having a plurality of cutting teeth 29 disposed along it. It is to be understood that the teeth 29 are splayed slightly to each side of the saw body or plate 20 so that the cut width (or kerf) is only slightly wider than the saw body or plate 20 itself. The cut width is approximately 0.060 to 0.062 inches. In this fashion, the saw body or plate 20 does not bind in the cut (not shown) being made in the material (also not shown) that is to be cut. It is also to be understood that the number of cutting teeth 29 shown in FIG. 1 is not a limitation of the present invention. Additionally, it is to be understood that the plate 20 and assembly 10 could be configured as a knife-type cutter without teeth, or “slitter,” such a cutter being used for side trimming or slitting rolls of material into multiples (or “mults”), and such a slitter also being within the scope of the present invention.

Additional secondary holes 26 are defined in the proximal portion 24 of the saw blade or plate 20. See FIG. 3 in particular. The purpose and function of the secondary holes 26 will be apparent later in this detailed description.

Referring again to FIG. 1, it will be seen that the first collar or spacer 30 is provided and is disposed to one side 21 of the saw body or plate 20. See also FIG. 2. The first collar or spacer 30 similarly comprises a disk-like structure having a center spindle hole 32, a first spacer portion 34 that is proximal to the center spindle hole 32, a second spacer portion 38 that is distal to the center spindle hole 32, and a plurality of secondary holes 36 defined about the distal or second portion 38 of the first collar or spacer 30. The first collar or spacer 30 has a diameter that is substantially less than the diameter of the saw body 20.

Continuing with FIG. 2, it will be seen that a second collar or spacer 40 is provided and is disposed to the other side 23 of the saw body or plate 20, opposite the first collar or spacer 30. The second collar or spacer 40 similarly comprises a center spindle hole 42, a first spacer portion 44 that is proximal to the center spindle hole 42, a second spacer portion 48 that is distal to the center spindle hole 42, and a plurality of secondary holes 46 defined about the distal or second portion 48 of the second collar or spacer 40. The second collar or spacer 40 likewise has a diameter that is substantially less than the diameter of the saw body 20.

In the first preferred embodiment, the center spindle holes 22, 32, 42 of the saw body or plate 20 and the collars or spacers 30, 40, respectively, are aligned or co-axial and are structurally adapted to allow the assembly 10 to be slid onto an arbor spindle (not shown). The assembly 10 is then secured to the spindle with a spindle nut (also not shown) in accordance with prior art, spindles and spindle nuts being well known in the art.

Similarly, each of the secondary holes 26 in the saw body or plate 20 and each of the secondary holes 36, 46 in the collars or spacers 30, 40 are likewise aligned or co-axial. In that fashion, a fastener 6 can be inserted through the co-axial secondary holes 26, 36, 46 and a fastener head 16 applied at each side of the saw blade assembly 10 to secure the collars or spacers 30, 40 to the saw body or plate 20. See FIG. 3 in particular. It is to be understood that, in this preferred embodiment, the secondary holes 26, 36, 46 are three in number, but that any number of such holes could be used without deviating from the scope of the present invention.

It is also to be understood that the fastener 6 could be replaced by a like structure such as a rivet, a screw, nuts and bolts, solder, glue or other types of fastening methods that would likewise secure the collars 30, 40 to the saw body or plate 20 to strengthen the plate 20 and to reduce the wobbling problems that are inherent in saw blades of this type, particularly saw blades that are of a thin thickness.

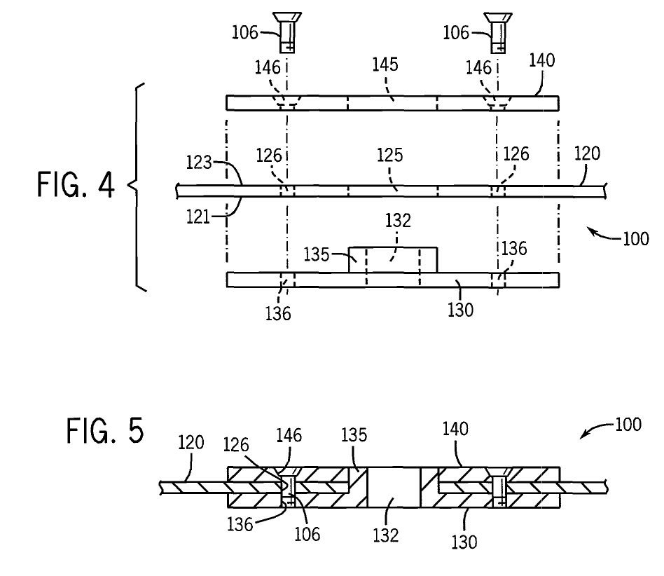

In a second preferred embodiment, which is illustrated in FIGS. 4 and 5, it will similarly be seen that the assembly 100 comprises a pair of collars or spacers 130, 140, the collars or spacers 130, 140 not being like configured. Each is disposed to one side 121, 123 of a saw body or plate 120. The saw body or plate 120 comprises substantially the same structure as the saw body or plate 20 discussed above with one exception. Instead of a center spindle hole, the saw body or plate 120 comprises a center hole 125 the diameter of which is somewhat larger than what the diameter of a spindle hole would normally be. The reason for this is that the first collar or spacer 130 is provided with an integrally-formed central bushing portion 135. The central bushing portion 135 comprises a center spindle hole 132. The first collar or spacer 130 is disposed to one side 121 of the saw body or plate 120. The center hole 145 of the second collar or spacer 140 is of an inner diameter that substantially matches the outer diameter of the central bushing portion 135. Similarly, the center hole 125 of the saw body or plate 120 is of a diameter that substantially matches the outer diameter of the central bushing portion 135. In this configuration, the saw body or plate 120 can be positioned adjacent the first collar or spacer 130 and the second collar or spacer 130 can be positioned adjacent the saw body or plate 120 at the second side 123 thereof.

Once components of the assembly 100 are positioned as shown in FIG. 5, a plurality of secondary holes 126, 136, 146 in the saw body or plate 120 and the collars or spacers 130, 140, respectively, are aligned or are co-axial and fasteners 106 can then be used to secure the assembly 100 in the same fashion as was described above relative to the first embodiment. As shown in FIG. 5, for example, the fasteners are threaded machine screws 106 and the secondary holes 136 defined in the first collar or spacer 130 are like-threaded.

Lastly, it is to be understood that, in either embodiment of the present invention, the saw blade assembly 10, 100 could be used with most any material that can be cut, including, but not limited to, wood, metal, fiberglass, vinyl, plastic, paper, rubber, cloth or other material.

In accordance with the foregoing, it will be seen that there has been provided a new and useful saw blade and saw blade assembly that produces a superior quality end product for the consumer, and at a lower cost. In addition, the saw blade and saw blade assembly of the present invention provides a thinner, but substantially stronger, saw blade that is able to cut through deeper material, is more accurate in cutting, and is easier for the operator to load onto the spindle arbor. Additionally, the support structure that is used in the saw blade and saw blade assembly of the present invention helps eliminate harmonic vibrations of the saw blade steel.

The details of the invention having been disclosed in accordance with the foregoing, we claim:

1. A saw blade assembly comprising:
a disk-like saw plate, the saw plate comprising a center spindle hole, a saw plate portion that is proximal to the center spindle hole and a saw plate portion that is distal to the center spindle hole, the saw body further comprising a first side, a second side and a peripheral edge;
a plurality of secondary holes defined within the proximal saw plate portion;
a first collar, the first collar comprising a center spindle hole, a first collar portion that is proximal to the center spindle hole of the first collar and a second collar portion that is distal to the center spindle hole of the first collar;
a plurality of secondary holes defined within the distal portion of the first collar;
a second collar, the second collar comprising a center spindle hole; a second collar portion that is proximal to the center spindle hole of the second collar and a second collar portion that is distal to the center spindle hole of the second collar;
a plurality of secondary holes defined within the distal portion of the second collar; and
a plurality of fasteners;
wherein the first collar is positioned adjacent the first side of the saw plate;
wherein the second collar is positioned adjacent the second side of the saw plate; and
wherein the secondary holes of the saw plate, the first collar and the second collar are aligned for receiving the plurality of fasteners there through.

2. The saw blade assembly of claim 1 wherein the saw plate comprises a diameter and wherein the first collar and the second collar each has a diameter that is substantially less than the diameter of the saw plate, the diameter of the first collar and the second collar being substantially identical.

3. The saw blade assembly of claim 1 wherein the fasteners are selected from a group consisting of rivets, screws, nuts and bolts, solder or glue, or a combination thereof.

4. The saw blade assembly of claim 1 wherein the plurality of secondary holes is three in number.

5. The saw blade assembly of claim 1 wherein the peripheral edge of the saw plate comprises a kerf edge having a plurality of splayed cutting teeth disposed along it.

6. The saw blade assembly of claim 1 wherein the peripheral edge of the saw plate comprises a knife-type cutter without teeth.

7. The saw blade assembly of claim 1 wherein the saw plate has a thickness and the thickness is approximately 0.035 inches.

8. A saw blade assembly comprising:
a disk-like saw plate, the saw plate comprising a center hole, a saw plate portion that is proximal to the center hole and a saw plate portion that is distal to the center hole, the saw body further comprising a first side, a second side and a peripheral edge;
a plurality of secondary holes defined within the proximal saw plate portion;
a first collar, the first collar comprising an integrally-formed bushing having a center spindle hole, a first collar portion that is proximal to the bushing and center spindle hole and a second collar portion that is distal to the bushing and center spindle hole;
a plurality of secondary holes defined within the distal portion of the first collar;
a second collar, the second collar comprising a center hole; a second collar portion that is proximal to the center hole of the second collar and a second collar portion that is distal to the center hole of the second collar;
a plurality of secondary holes defined within the distal portion of the second collar; and
a plurality of fasteners;
wherein the first collar is positioned adjacent the first side of the saw plate;
wherein the bushing of the first collar is received within the center hole of the saw plate;
wherein the second collar is positioned adjacent the second side of the saw plate;
wherein the bushing of the first collar is received within the center hole of the second collar; and
wherein the secondary holes of the saw plate, the first collar and the second collar are aligned for receiving the plurality of fasteners there through.

9. The saw blade assembly of claim 8 wherein the saw plate comprises a diameter and wherein the first collar and the second collar each has a diameter that is substantially less than the diameter of the saw plate, the diameter of the first collar and the second collar being substantially identical.

10. The saw blade assembly of claim 8 wherein the fasteners are selected from a group consisting of rivets, screws, nuts and bolts, solder or glue, or a combination thereof.

11. The saw blade assembly of claim 8 wherein the plurality of secondary holes is three in number.

12. The saw blade assembly of claim 8 wherein the peripheral edge of the saw plate comprises a kerf edge having a plurality of splayed cutting teeth disposed along it.

13. The saw blade assembly of claim 8 wherein the peripheral edge of the saw plate comprises a knife-type cutter without teeth.

14. The saw blade assembly of claim 8 wherein the saw plate has a thickness and the thickness is approximately 0.035 inches.
